(19) United States
(12) Patent Application Publication
(10) Pub. No.: US 2009/0211127 A1
(43) Pub. Date: Aug. 27, 2009

(54) LICENSE PLATE HOLDER

(76) Inventor: GERALD R. OGDEN, Tacoma, WA (US)

Correspondence Address: WOOD AND EISENBERG, PLLC, 6911 RICHMOND HIGHWAY, SUITE 403, Alexandria, VA, 22306, US

(21) Appl. No.: 12/371,608

(22) Filed: Feb. 15, 2009

Related U.S. Application Data
(60) Provisional application No. 61/067,329, filed on Feb. 27, 2008.

(51) Int. Cl. G09F 7/18

(52) U.S. Cl. 40/209

(57) ABSTRACT

A foldable license plate holder includes a foldable sheet forming three panels bearing indicia, and two fold line locations. There is a top panel, a middle panel, and a bottom panel. Two holes are provided in the top and bottom panels, which when folded overlie matching holes in the middle panel. The holes serve to permit bolts, screws, or other types of license plate fasteners to pass through for mounting on a vehicle. At each fold line location, multiple fold lines are provided to that the foldable license plate holder can serve to hold license plates of different sizes and thicknesses.

### CROSS REFERENCE TO RELATED APPLICATIONS

This application claims priority to U.S. provisional application No. 61/067,329 which is incorporated herein by reference in its entirety.

### STATEMENT REGARDING FEDERALLY SPONSORED RESEARCH OR DEVELOPMENT

Not applicable.

### FIELD OF THE INVENTION

The present invention relates generally to license plate holders. More particularly, this invention is directed to a foldable license plate holder bearing indicia.

### BACKGROUND OF THE INVENTION

License plate holders are well known. Such license plate holders serve to retain a license plate on a vehicle.

Some known license plate holders bear indicia on one or more surfaces. It is a problem in the art to provide indicia such as marketing information on a simple, easy to use, and easy to assemble foldable license plate holder.

### SUMMARY OF THE INVENTION

From the foregoing, it is seen that it is a problem in the art to provide a device meeting the above requirements. According to the present invention, a device is provided which meets the aforementioned requirements and needs in the prior art.

Specifically, the device according to the present invention provides an apparatus or device to provide indicia such as marketing information on a simple, easy to use, and easy to assemble foldable license plate holder.

The device according to the present invention includes a foldable license plate holder having three panels bearing indicia, and two fold line locations. There is a top panel, a middle panel, and a bottom panel. Two holes are provided in the top and bottom panels, which when folded overlie matching holes in the middle panel. The holes serve to permit bolts, screws, or other types of license plate fasteners to pass through for mounting on a vehicle. At each fold line location, multiple fold lines are provided so that the foldable license plate holder can serve to hold license plates of different sizes and thicknesses.

Other objects and advantages of the present invention will be more readily apparent from the following detailed description when read in conjunction with the accompanying drawings.

### BRIEF DESCRIPTION OF THE DRAWINGS

FIG. 1 is side elevational view of a foldable license plate holder in an unfolded condition, according to the present invention.

FIG. 2 is a side elevational view of the foldable license plate holder of FIG. 1, in a partially folded condition.

FIG. 3 is a side elevational view of the foldable license plate holder of FIG. 1, in a fully folded condition.

FIG. 4 is a front elevational view of the foldable license plate holder of FIG. 1 in the unfolded condition, showing indicia on one panel.

FIG. 5 is a front elevational view of the foldable license plate holder of FIG. 1 in the folded condition corresponding to that shown in FIG. 3, showing indicia on three panels.

FIG. 6 is a side elevational view of the foldable license plate holder of FIG. 1 in the unfolded condition, with numerals indicating the locations of indicia on the three panels.

### DETAILED DESCRIPTION OF THE INVENTION

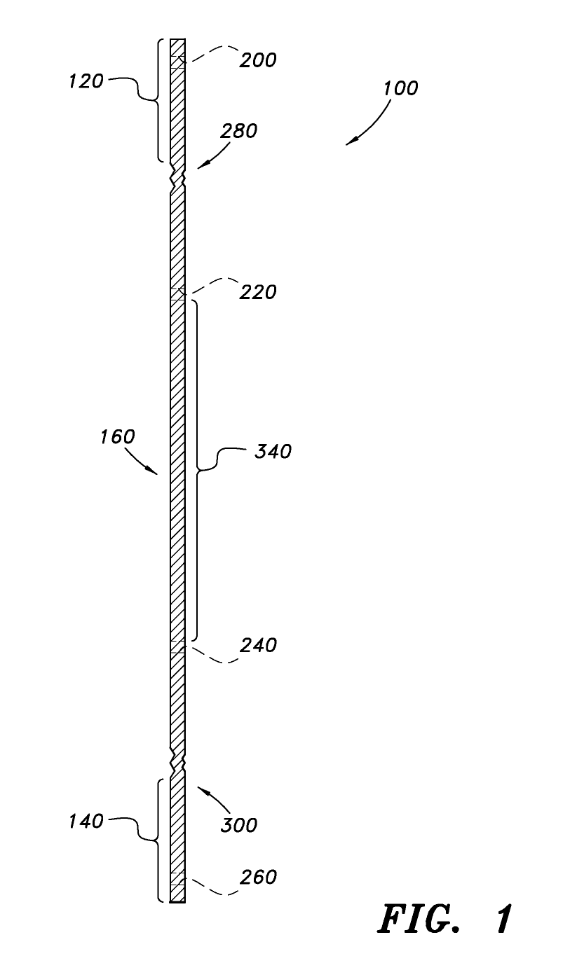

FIG. 1 is side elevational view of a foldable license plate holder 100 in an unfolded condition. In this view, the foldable license plate holder 100 includes a foldable sheet forming three panels 120, 140, and 160 capable of bearing indicia, and two fold line locations 280 and 300. Specifically, there is a top panel 120, a middle panel 160, and a bottom panel 140. The fold line location 280 separates the top panel 120 and the middle panel 160. The fold line location 300 separates the middle panel 160 and the bottom panel 140.

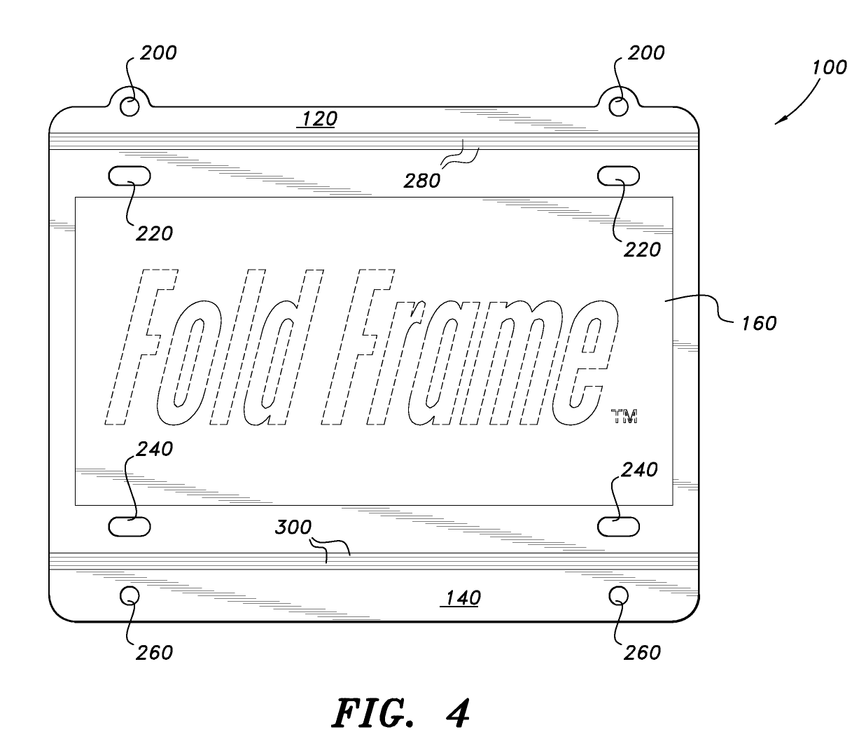

As shown in FIGS. 1 and 4, two holes 200 are provided in the top panel 120, and two holes 260 are provided in the bottom panel 140. Four holes 220, 240 are provided in the middle panel 160, such that when the top panel 120 and the bottom panel 140 are in a folded condition, the two holes 200 overlie the two holes 220, and the two holes 260 overlie the two holes 240. The holes 200, 220, 240, and 260 serve to permit bolts, screws, or other types of license plate fasteners to pass through for mounting on a vehicle.

As shown in FIGS. 1 and 4, at each of the fold line locations 280 and 300, multiple fold lines are provided so that the foldable license plate holder can serve to hold license plates of different sizes and thicknesses. Also, in the case of metal or plastic, the multiple fold lines serve as a hinge, and the folding does not occur at only a single one of the lines but instead some folding or bending occurs at each of the individual fold lines.

The material used to form the foldable license plate holder 100 can be flexible metal such as aluminum or thin sheet steel or other metal alloy. Also, some types of plastic materials are sufficiently flexible for this purpose, and can also be used herein. Paper material such as coated paper, specialty paper, or plastic-coated paper can be used as well.

The sizes of the top panel 120 and the bottom panel 140 are such that they do not obscure important information on state license plates.

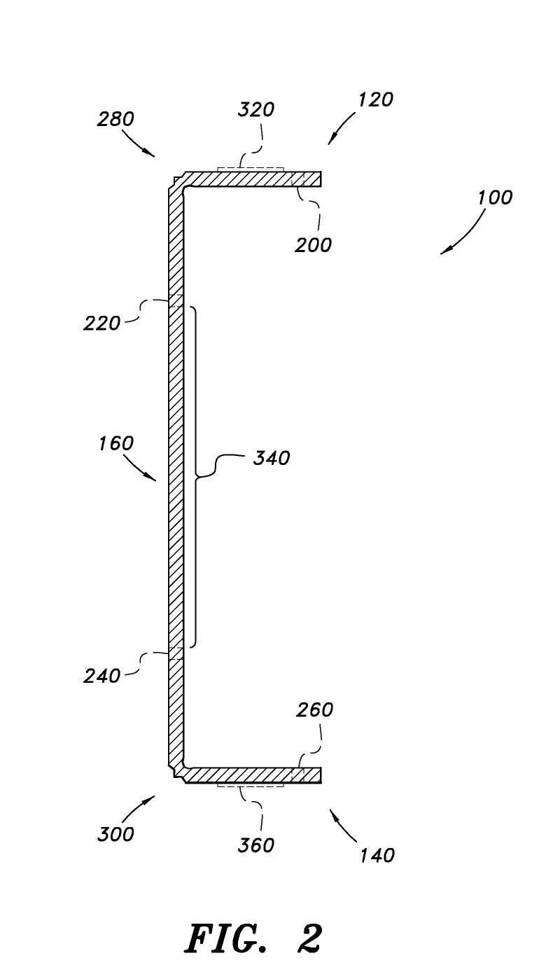

FIG. 2 is a side elevational view of the foldable license plate holder 100 of FIG. 1, in a partially folded condition. The parts are as shown and named hereinabove with reference to FIG. 1. In this figure, locations of the indicia are indicated by numeral 320 for indicia located on the top panel 120, numeral 340 for indicia located on the middle panel 160, and numeral 360 for indicia located on the bottom panel 140.

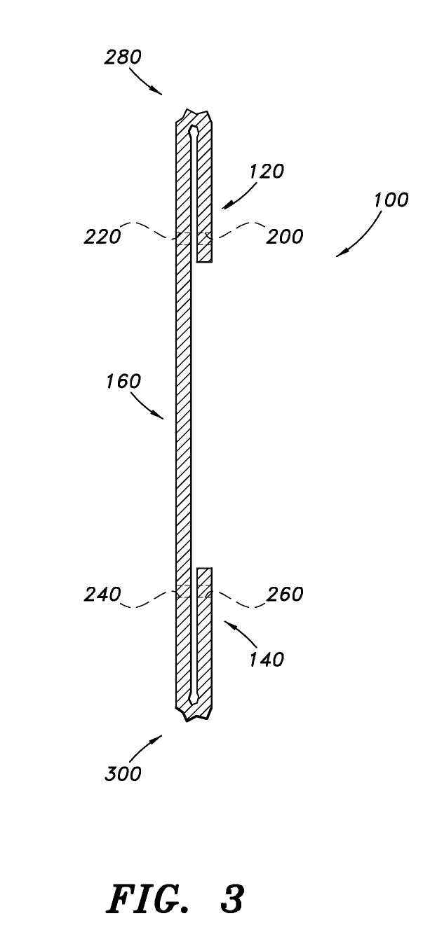

FIG. 3 is a side elevational view of the foldable license plate holder 100 of FIG. 1, in a fully folded condition. The parts are as shown and named hereinabove with reference to FIG. 1. Here, it is shown that the holes 200 and 220 line up, and that the holes 240 and 260 line up.

FIG. 4 is a front elevational view of the foldable license plate holder of FIG. 1 in the unfolded condition, showing indicia on the middle panel 160. This indicia serves as advertising or marketing material or information, and is visible when the vehicle is displayed for sale. Once a license plate is installed, it will cover the indicia on the middle panel 160. There is no indicia visible on the front of the top panel 120 or the front of the bottom panel 140, although such indicia could be provided if desired.

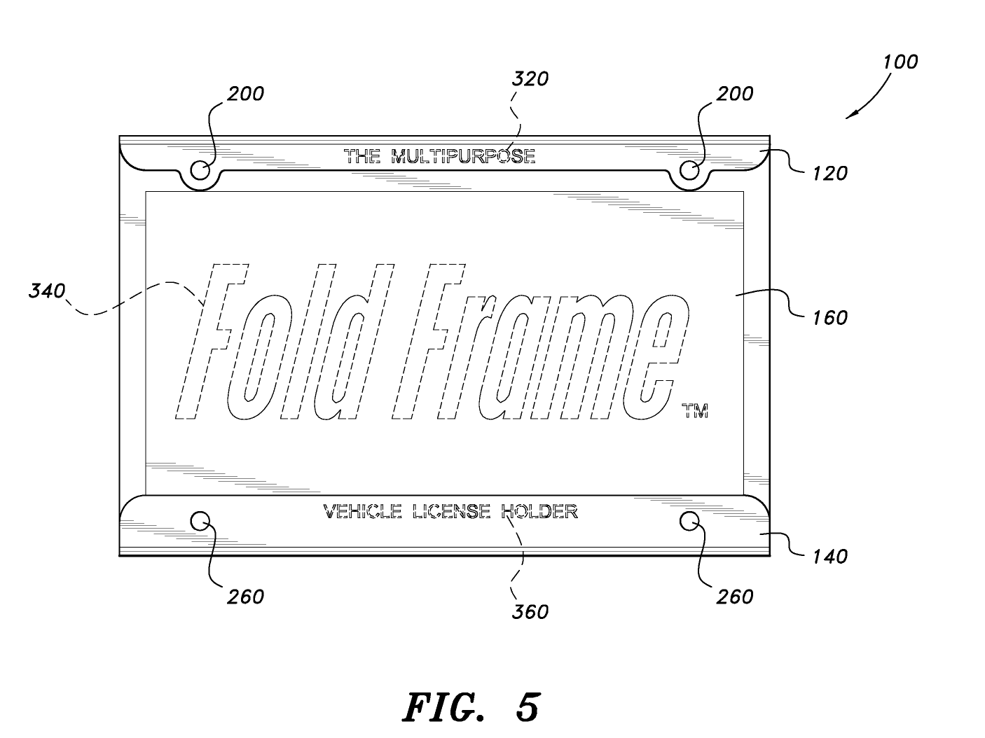

FIG. 5 is a front elevational view of the foldable license plate holder 100 of FIG. 1 in the folded condition corresponding to that shown in FIG. 3, showing indicia on all three panels 120, 140, and 160.

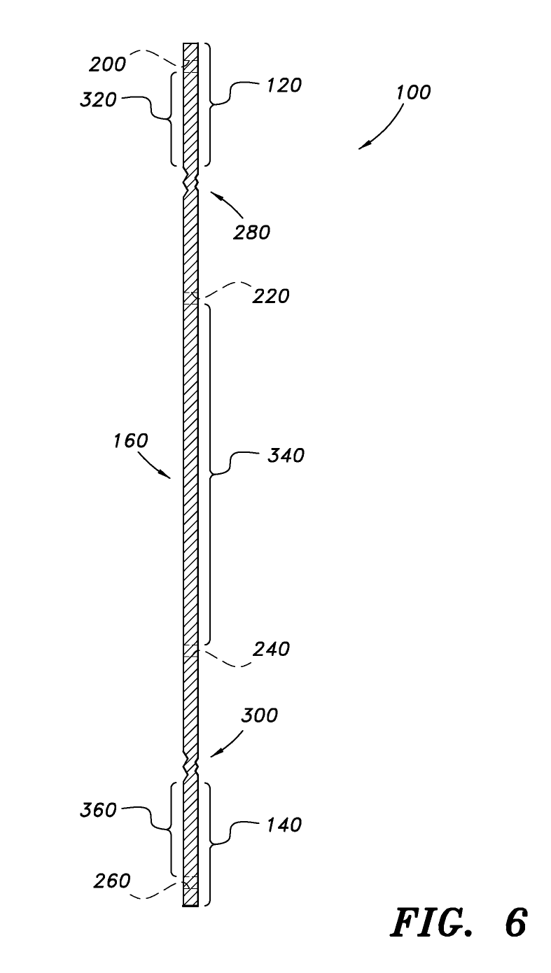

FIG. 6 is a side elevational view of the foldable license plate holder 100 of FIG. 1 in the unfolded condition, with numerals indicating the locations of indicia 320, 340, and 360 on the three panels 120, 140, and 160.

The invention being thus described, it will be evident that the same may be varied in many ways by a routineer in the applicable arts. Such variations are not to be regarded as a departure from the spirit and scope of the invention and all such modifications are intended to be included within the scope of the claims.

What is claimed is:

1. A foldable license plate holder, comprising:
a foldable sheet body having a top panel, and middle panel, and a bottom panel;
a first fold line location connecting the top panel and the middle panel;
a second fold line location connecting the middle panel and the bottom panel; and
indicia disposed on one surface of the middle panel.

2. A foldable license plate holder as claimed in claim 1, wherein the first fold line location and the second fold line location each respectively include a plurality of fold lines.

3. A foldable license plate holder as claimed in claim 2, wherein each of the fold lines are formed as thin depressions.

4. A foldable license plate holder as claimed in claim 1, wherein each of the fold lines are formed as perforations in the material forming the body.

5. A foldable license plate holder as claimed in claim 1, wherein the body is formed of metal.

6. A foldable license plate holder as claimed in claim 1, wherein the body is formed of plastic.

7. A foldable license plate holder as claimed in claim 1, wherein the body is formed of paper.

8. A foldable license plate holder as claimed in claim 1, wherein the body is formed of plastic coated paper.

9. A foldable license plate holder as claimed in claim 1, wherein the body has a front side and a rear side; and wherein indicia is provided on the front side of the middle panel, and indicia is provided on the rear side of the top panel and on the rear side of the bottom panel.

10. A foldable license plate holder, comprising:
a foldable sheet body having a top panel, and middle panel, and a bottom panel;
a first fold line location connecting the top panel and the middle panel;
a second fold line location connecting the middle panel and the bottom panel; and
indicia disposed on one surface of the middle panel;
the first fold line location and the second fold line location each respectively include a plurality of fold lines; and
the body has a front side and a rear side; and wherein indicia is provided on the front side of the middle panel, and indicia is provided on the rear side of the top panel and on the rear side of the bottom panel.
